(19) United States
(12) Patent Application Publication
(10) Pub. No.: US 2019/0099249 A1
(43) Pub. Date: Apr. 4, 2019

(54) TOOTH CLEANING TOOL HAVING A FRONT END FOR ALTERNATIVELY AND RESPECTIVELY REPLACING A PLURALITY OF MULTIFUNCTIONAL AND DISPOSABLE TOOTH CLEANING HEADS

(71) Applicants: Hongmin LAI, Taipei City (TW); Yi-Chung CHEN, Taipei City (TW)

(72) Inventors: Hongmin LAI, Taipei City (TW); Yi-Chung CHEN, Taipei City (TW)

(21) Appl. No.: 15/951,248

(22) Filed: Apr. 12, 2018

(30) Foreign Application Priority Data
Sep. 29, 2017 (TW) 106214495

(51) Int. Cl. A61C 15/04; A46B 9/04; A46B 5/00; A46B 5/02

(52) U.S. Cl. CPC A61C 15/048; A46B 9/045; A46B 15/0071; A46B 5/021; A46B 2200/1066; A46B 5/0095

(57) ABSTRACT

The present invention is to provide a tooth cleaning tool having a handle and at least one of a plurality of tooth cleaning heads, wherein the handle has two ends extending from a middle section thereof to form a first included angle ranging from 155° to 175° between the two ends, and a front end of the handle is protruded with a connector; and the tooth cleaning heads each has a cone shaped supporting rod and a cleaning component disposed at or adjacent to a tip end of the supporting rod and extending in a direction to form a second included angle ranging from 90° to 135° therebetween; and a connection receptacle is disposed at a base end of the supporting rod and configured to firmly join together with the connector such that the handle and tooth cleaning head can he coupled together for providing a specific tooth cleaning function.

### FIELD OF THE INVENTION

This invention relates generally to dental hygiene, and more particularly to a tooth cleaning tool not only having a dentally ergonomic and durable handle for simplifying the structure thereof as well as for encouraging the user to use the tooth cleaning tool in a proper way for a long period of time, but also having a plurality of multifunctional and disposable tooth cleaning heads (such as a tooth brush head, a dental floss pick head, or an interdental brush head . . . etc.) capable of being alternatively and respectively attached to a front end of the ergonomic and durable handle for providing specific tooth cleaning functions according to the user's specific needs.

### BACKGROUND

Nowadays, due to the high educational standard and living standard in the developed or advanced countries, nearly all people living there are well aware of the importance of oral hygiene and the need of regular tooth brushing, so as to effectively remove food deposits that can lead to bacterial buildup and result in dental problems, e.g., caries (cavities), gingivitis, and periodontitis, etc. However, merely brushing the teeth is not likely to remove all, or nearly all, of the residual food deposits and plaque that accumulate in the mouth, particularly between the teeth. Accordingly, nearly all dentists and oral hygiene specialists always recommend regular flossing between the teeth in order to remove deposits that typically cannot be removed by tooth brushing.

While most people probably recognize the value of regular flossing, the actual act of flossing between the teeth is often relatively more difficult than brushing. This can be particularly true of individuals with closely spaced teeth, where it can he difficult to work a strand of dental floss between the teeth. Even in the case of individuals having normally spaced teeth, it can likewise be difficult for many individuals to manipulate dental floss, particularly if they are arthritic or have some other infirmity that affects their dexterity.

In addition to the above considerations, many people who floss regularly may do so incorrectly. Proper flossing technique typically requires the floss to be drawn down between the teeth, and then lifted back up between the teeth while being drawn upward along the surfaces of the teeth. Use of an improper technique of drawing the floss back and forth laterally across the bases of the teeth has been known to actually cut grooves across the bases of the teeth after prolonged and continuous doing of this action, thus causing much more harm than good to the teeth.

Though tooth brushes have already been the most fundamental tools for almost everyone's oral hygiene, however, current designs of the ordinary tooth brushes are less than ideal, and are difficult for accessing to the lingual sides of the user's posterior teeth. Although everyone knows that interdental cleaning is more important than simply brushing the surfaces of teeth, most people just don't like to use dental floss because it is not user-friendly. Instead of tooth brush and dental floss, interdental brush and straight floss pick are nowadays favorable to many people as an alternative of the dental floss and are currently always being offered by many restaurants to their customers. While using the interdental brush or the straight floss pick, one end of it has to be firmly gripped by two fingers (such as index finger and thumb) of a user for enabling the other end thereof to approach and then access the interdental gap through the user's mouth corner which also makes the cleaning action very difficult to he implemented due to the handles of the dental floss picks and interdental brushes are too short and too thin for users to grip. Furthermore, it is also very difficult for users to clean their posterior teeth through using the dental floss picks or clean lingual teeth through using the interdental brushes due to the limited total length thereof.

Thus, it is very important to effectively improve the aforesaid tooth cleaning tools, such as the traditional tooth brush, dental floss pick, or interdental brush . . . etc., through creating a whole new tooth cleaning tool which not only has a dentally ergonomic and durable handle for simplifying the structure thereof as well as for encouraging the user to use the tooth cleaning tool in a proper way for a long period of time, but also has at least one of a plurality of multifunctional and disposable tooth cleaning heads (such as a tooth brush head, a dental floss pick head, or an interdental brush head . . . etc.) capable of being alternatively and respectively attached to a front end of the ergonomic and durable handler, for providing specific tooth cleaning functions according to the user's specific needs.

### SUMMARY OF THE INVENTION

It is an objective of the present invention to provide a tooth cleaning tool not only having a dentally ergonomic and durable handle, but also having at least one of a plurality of multifunctional and disposable tooth cleaning heads (such as a tooth brush head, a dental floss pick head, or an interdental brush head . . . etc. capable of being alternatively and respectively attached to a front end of the ergonomic and durable handle for providing specific tooth cleaning functions according to the user's specific needs. Thus, when the tooth cleaning head becomes worn-out and unusable, it can be discarded and easily be replaced by the other new and usable tooth cleaning head, the ergonomic and durable handle can still be used along with the other tooth cleaning head for a long period of time, so as to effectively avoid the ergonomic and durable handle from being discarded and causing unnecessary waste of natural resource and to effectively protect our natural environment.

The primary objective of the present invention is to provide a tooth cleaning tool having a front end for alternatively and respectively replacing a plurality of multifunctional and disposable tooth cleaning heads, which comprises an ergonomic and durable handle and at least one of a plurality of multifunctional and disposable tooth cleaning heads, wherein the ergonomic and durable handle is configured in a user-friendly curvature to automatically guide a user to retract his or her cheeks or tongues while the handle is entering into his or her mouth, for facilitating the user to clearly visualize the posterior teeth of the user and facilitating the tooth cleaning head to approach and access the posterior teeth and lingual teeth, which make the tooth cleaning tool of the present invention to be an all-in-one designed tool not only capable of helping people to clean teeth more effectively, but also preserving the ergonomic and durable handle as a long term used element for avoiding from unnecessarily wasting natural resource and causing environmental pollution. In addition, the ergonomic and durable handle has two opposite ends (i.e. a front end and a rear end) extending from a middle section thereof to form a first included angle, which ranges from 155° to 175°, between two tangent lines of the two opposite ends, and the front end of the ergonomic and durable handle is protruded with a connector; and each of the multifunctional and disposable tooth cleaning heads has a cone shaped supporting rod and a cleaning head component, wherein the cleaning head component is disposed at or adjacent a tip end of the supporting rod and extends in a direction to form a second included angle, which ranges from 90° to 135°, between a central line of the cleaning head component and the central line of the supporting rod; and a connection receptacle is disposed at a base end of the supporting rod and is configured to firmly join together with the connector such that the ergonomic and durable handle and a corresponding one of the multifunctional and disposable tooth cleaning heads can be alternatively and respectively coupled together to form a specific tooth cleaner for providing a specific tooth cleaning function to the user as required, thereby allowing the user to stretch his or her mouth wide open by the ergonomic and durable handle for enabling the user to clearly visualize their posterior teeth and lingual teeth and then enabling the user to easily and accurately manipulate the corresponding tooth cleaning heads for approaching their posterior teeth and lingual teeth and accessing the interdental gap thereof through their mouth corner in a correct way.

It is another objective of the present invention that the multifunctional and disposable tooth cleaning heads can be a tooth brush head, a dental floss pick head, or an interdental brush head . . . etc., so as to provide specific tooth cleaning functions according to the user's specific needs.

It is still another objective of the present invention that the connector corresponds in shape and cross section to the connection receptacle and, in a preferred embodiment of the present invention, the connector and the connection receptacle are of semicircular cross sections such that the tooth cleaner is direction-sensitive in its entirety.

It is still another objective of the present invention that the ergonomic and durable handle is of a polygonal cross section, not only for helping user to firmly and easily grip the ergonomic and durable handle, but also for serving an anti-skid purpose.

### BRIEF DESCRIPTIONS OF THE DRAWINGS

FIG. 1 is a side view of the tooth cleaning tool of the present invention;

FIG. 2 is an exploded drawing of a preferred embodiment of the tooth cleaning tool of the present invention having a front end for replacing three multifunctional and disposable tooth cleaning heads, alternatively, and, respectively;

FIG. 3 is an exploded drawing of the tooth cleaning tool of the present invention having an ergonomic and durable handle configured with a user-friendly curvature, and a tooth brush head attached to a front end of the ergonomic and durable handle;

FIG. 4 is a side view of the knife-like dental floss pick head of the present invention; and

FIG. 5 is a schematic view of manipulating the ergonomic and durable handle of the tooth cleaning tool of the present invention to stretch a user's mouth wide open for enabling the user to clearly visualize the user's posterior teeth and lingual teeth and then facilitating the interdental brush head to approach from both buccal and lingual or facial and palatal sides and then access interdental gap between tooth; and

FIG. 6 is a schematic view of manipulating the ergonomic and durable handle of the tooth cleaning tool of the present invention to stretch a user's mouth wide open for enabling the user to clearly visualize the user's posterior teeth and lingual teeth and then facilitating the rake-like dental floss pick head to approach and access the posterior teeth and lingual teeth.

Objectives, features, and advantages of the present invention are hereinafter being illustrated along with some specific preferred embodiments in conjunction with the above drawings. However, the present invention can also be implemented or applied in accordance with any other variant embodiments.

### DETAILED DESCRIPTIONS OF THE EMBODIMENTS OF THE PRESENT INVENTION

Various modifications and changes may be made to the details described in the specification from different perspectives and for different applications without departing from the spirit of the present invention. The accompanying drawings mentioned above are deemed illustrative and thus are not drawn to scale. Hence, the embodiment presented below is an illustrative of the technical features of the present invention rather than a restrictive of the claims of the present invention.

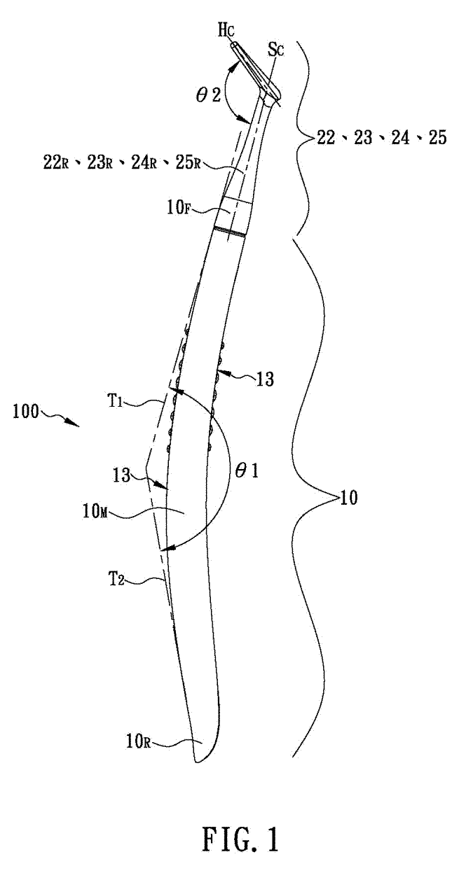

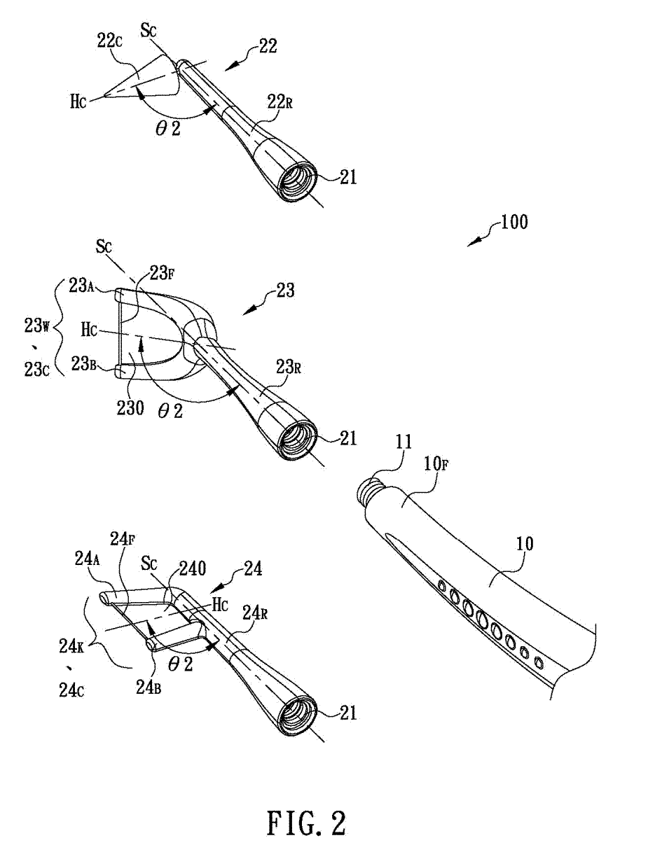

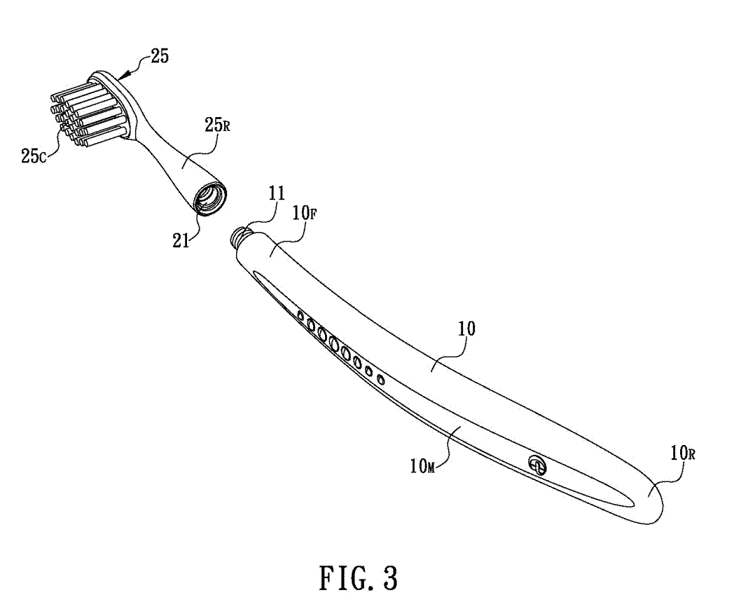

FIG, 1 is a schematic view of a tooth cleaning tool 100 according to a preferred embodiment of the present invention. As shown in FIG, 1, the tooth cleaning tool 100 comprises an ergonomic and durable handle 10 and at least one of a plurality of multifunctional and disposable tooth cleaning heads 22, 23, 24 or 25; wherein, please refer to FIGS. 1 and 3 of the present invention, the ergonomic and durable handle 10 is made of a plastic material or a metal material, and is configured with a user-friendly curvature 13 to guide a user to automatically retract his or her cheeks or tongues, respectively, while a front half part of the ergonomic and durable handle 10 is entering into the user's mouth, so as to facilitate the user to clearly visualize the posterior teeth and lingual teeth in his or her mouth from a mirror before he or she and, in the meanwhile, to facilitate the tooth cleaning head 22, 23, 24 or 25 to approach and access the posterior teeth and lingual teeth of the user. In the above preferred embodiment of the present invention, please again refer to FIGS. 1 and 3, the ergonomic and durable handle 10 has two opposite ends (i.e. a front end 10_{F} and a rear end 10_{R}) extending from a middle section 10ₘ thereof to form a first included angle θ_{1′} which ranges from 155° to 170° between a tangent line T₁ of the front end 10_{F}, and a tangent line T₂ of the rear end 10_{R}. And, please refer to FIG. 2 of the present invention, the front end 10_{F} of the ergonomic and durable handle 10 is protruded with a connector 11; and each of the multifunctional and disposable tooth cleaning heads 22, 23, 24 or 25 has a cone shaped supporting rod 22_{R}, 23_{R}, 24_{R} or 25_{R} and a cleaning head component 22_{C}, 23_{C}, 24_{C} or 25_{C}, wherein the cleaning head component 22_{C}, 23_{C}, 24_{C} or 25_{C} is disposed at or adjacent to a tip end of the supporting rod 22_{R}, 23_{R}, 24_{R} or 25_{R} and extends in a direction to form a second included angle θ₂, which ranges from 90° to 135°, between a central line H_{C} of the cleaning head component 22_{C}, 23_{C}, 24_{C} or 25_{C} and a central line S_{C} of the supporting rod 22_{R}, 23_{R}, 24_{R} or 25_{R}. Please again refer to FIG. 2 of the present invention, a connection receptacle 21 is disposed at a base end of the supporting rod 22_{R}, 23_{R}, 24_{R} or 25_{R} and is configured to firmly join together with the connector 11, such that the ergonomic and durable handle 10 and a corresponding one of the multifunctional and disposable tooth cleaning heads 22, 23, 24 or 25 can be alternatively and respectively coupled together to form a specific tooth cleaner as shown in FIG. 3 for providing a specific tooth cleaning function (such as tooth brushing) to the user as required, thereby allowing the user to stretch his or her mouth wide open by the ergonomic and durable handle 10 for enabling the user to clearly visualize his or her posterior teeth and lingual teeth from the mirror before he or she and then enabling the user to easily and accurately manipulate the corresponding tooth cleaning head component 22_{C}, 23_{C}, 24_{C} or 25_{C} for approaching his or her posterior teeth and lingual teeth and accessing the interdental gap thereof through his or her mouth corner in a correct way.

Again referring to FIG.1 of the present invention, due to the user-friendly curvature 13, the configuration of the rear half part (i.e. a half part of the ergonomic and durable handle 10 adjacent to the rear end 10_{R} thereof) of the ergonomic and durable handle 10 is easy to be firmly gripped by two fingers (such as index finger and thumb) of a user, so as for enabling the user to use the front half part (i.e. a half part of the ergonomic and durable handle 10 adjacent to the front end 10_{F} thereof) of the ergonomic and durable handle 10 to enter his or her mouth for stretching his or her mouth wide open, thereby enabling the user to clearly visualize his or her posterior teeth and lingual teeth from the mirror before he or she, and then to easily and accurately manipulate the corresponding tooth cleaning head component 22_{C}, 23_{C}, 24_{C} or 25_{C} for approaching his or her posterior teeth and lingual teeth and accessing the interdental gap thereof through his or her mouth corner in a correct way.

Again referring to FIG. 3 of the present invention, in the preferred embodiment of the present invention, the connection receptacle 21 of the supporting rod 22_{R}, 23_{R}, 24_{R} or 25_{R} of the tooth cleaning head 22, 23, 24 or 25 and the connector 11 of the ergonomic and durable handle 10 are configured to be firmly jointed together such that the tooth cleaning head component 22_{C}, 23_{C}, 24_{C} or 25_{C} and the ergonomic and durable handle 10 can be coupled together to form a tooth cleaner, as shown in FIG. 3, the tooth cleaner is exemplified by a toothbrush head component 25_{C}. Again referring to the embodiment of FIG. 3, the connector 11 is, for example, a protruding portion, whereas the connection receptacle 21 is, for example, a connection receptacle 21 configured to receive the protruding portion (the connector 11) such that the tooth cleaning head 22, 23, 24 or 25 can be disconnectibly jointed to the front end 10_{F} of the ergonomic and durable handle 10, however, the present invention is not limited thereto. In a variant embodiment, the connector 11 and the connection receptacle 21 may be jointed together in another way. Please again refer to FIG. 3, the tooth cleaning head 25 in the preferred embodiment of the present invention is a toothbrush head which includes a cone shaped supporting rod 25_{R} and tooth brushes 25_{C}, wherein each of the tooth brushes 25_{C} has one end connected to the supporting rod 25_{R} adjacent to a tip end thereof and the other end extending in a direction to form a second included angle θ₂, which ranges from 90° to 135°, between a central line of the tooth brush 25_{C} and a central line of the supporting rod 25_{R}. Thus, when the brushes 25_{C} of the toothbrush head 25 are worn-out and become unusable, all a user needs to do is to unfasten the tooth cleaning head 25 (toothbrush head) from the front end 10_{F} of the ergonomic and durable handle 10 and discard the unusable tooth cleaning head 25, and then joint another toothbrush head 25 having whole new and useable tooth brushes 25_{C} to the front end 10_{F} of the ergonomic and durable handle 10. After doing so, the user is able to keep the ergonomic and durable handle 10 for a long term use, and only needs to change the tooth cleaning head 22, 23, 24 or 25 when the tooth cleaning head component 22_{C}, 23_{C}, 24_{C} or 25_{C} is worn-out and unusable. In other embodiments of the present invention, the ergonomic and durable handle 10 has a polygonal cross section, so as not only for helping the user to easily and firmly grip the ergonomic and durable handle 10, but also for providing anti-skid purposes to the user while gripping the ergonomic and durable handle 10.

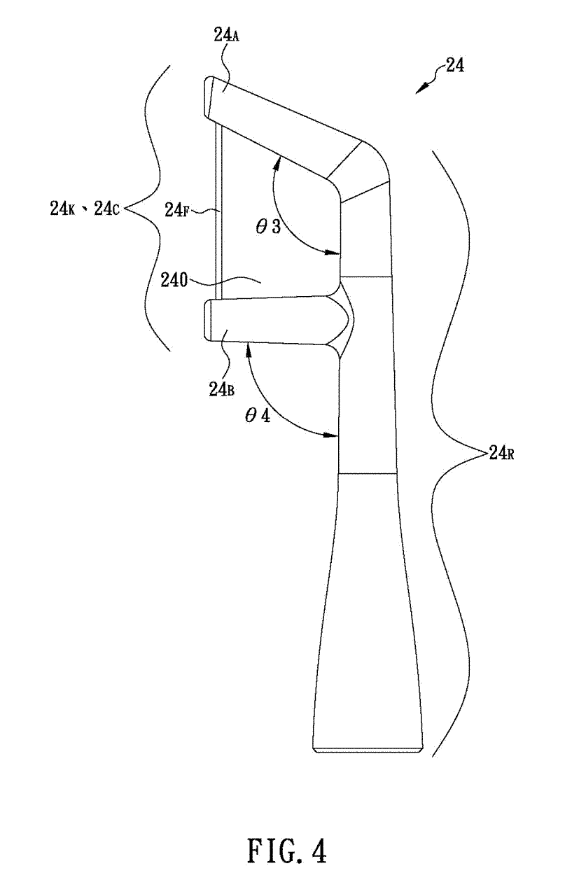

Please again refer to FIGS. 1 and 2 of the present invention, in a variant embodiment, the tooth cleaning head 22, 23, 24 or 25 can be any type of tooth cleaning head each having a different tooth cleaning head component 22_{C}, 23_{C}, 24_{C} or 25_{C}. FIG. 2 is a schematic view of a tooth cleaning tool of the present invention including at least one of a plurality of multifunctional and disposable tooth cleaning heads 22, 23 or 24 and an ergonomic and durable handle 10, as a kit 100 of the tooth cleaning tool, instead of a toothbrushing head 25 shown in FIG. 3, please again refer to FIG. 2 of the present invention, the tooth cleaning heads 22, 23 or 24 can be an interdental brush head 22, a rake-like dental floss pick head 23, or a knife-like dental floss pick head 24, . . . etc, wherein, the interdental brush head 22 includes a cone shaped supporting rod 22_{R} and an interdental brush 22_{C}, wherein the interdental brush 22_{C} has one end connected to a tip end of the supporting rod 22_{R} and the other end extending in a direction to form a second included angle θ₂, which ranges from 90° to 135°, between a central line H_{C} of the interdental brush 22_{C} and a central line S_{C} of the supporting rod 22_{R}; again referring to FIG. 2 of the present invention, the rake-like dental floss pick head 23 includes a cone shaped supporting rod 23_{R} and a rake-like dental floss pick 23_{W} or 23_{C}, wherein the rake-like dental floss pick 223_{W} or 23_{C} has two arms 23_{A}-23_{B} each having one end connected to a tip end of the supporting rod 23_{R} and the other end extending laterally from the supporting rod 23_{R} to form the second included angle θ₂, which ranges from 90° to 135°, between a central line H_{C} of the two arms 23_{A}-23_{B} and the central line S_{C} of the supporting rod 23_{R}, and wherein the other ends of the two arms 23_{A}-23_{B} are spaced with each other for defining a cavity 230 between the two arms 23_{A}-23_{B} and for holding a short strand of dental floss 23_{F} between the two arms 23_{A}-23_{B} across the cavity 230; please refer to FIGS. 2 and 4 of the present invention, the knife-like dental floss pick head 24 includes a cone shaped supporting rod 24_{R} and a knife-like dental floss pick 24_{K} or 24_{C}; again referring to FIG. 4 of the present invention, wherein the knife-like dental floss pick 24_{R} or 24_{C} has a first arm 24_{A} and a second arm 24_{B}; the first arm 24_{A} has one end connected to a tip end of the supporting rod 24_{R}, and the other end extending laterally from the supporting rod 24_{R} to form a third included angle θ₃, which is below 135°, between a central line of the first arm 24_{A} and the central line of the supporting rod 24_{R}; the second arm 24_{B} has one end connected to the supporting rod 24_{R} at a position adjacent to the tip end of the supporting rod 24_{R} and spaced with the first arm 24_{A}, and the other end extending laterally from the supporting rod 24_{R} to form a fourth included angle θ₄, which is above 45°, between a central line of the second arm 24_{B} and the central line of the supporting rod 24_{R}; and wherein the other ends of the first arm 24_{A} and the second arm 24_{B} are spaced with each other for defining a cavity 240 between the first arm 24_{A} and the second arms 24_{A} and for holding a short strand of dental floss 24_{F} between the first arm 24_{A} and the second arm 24_{A} across the cavity 240.

Thus, again referring to FIGS. 2 and 3 of this application, the tooth Meaning tool of the present invention can be a tooth cleaning kit 100 comprises an ergonomic and durable handle 10 and at least one of a plurality of tooth cleaning head 22, 23, 24 or 25, such as an interdental brush head 22, a rake-like dental floss pick head 23, a knife-like dental floss pick head 24, and a tooth brushing head 25, wherein, since the ergonomic and durable handle 10 is in a length which ranges from 7˜16 centimeters, and is far more longer than handles of the conventional tooth cleaning tools, such as the conventional dental floss picks and interdental brushes, which are usually too short and too thin to be firmly griped. By contrast, the tooth cleaning tool 100 of the present invention is advantageous in that the interdental brush head 22, the rake-like dental floss pick head 23, the knife-like dental floss pick head 24 or the tooth brushing head 25 can be selectively and respectively connected to the front end 10_{F} of the ergonomic and durable handle 10 for making an easy grip of the handle 10 and enhancing the ease and accuracy of manipulating the tooth cleaning head component 22_{C}, 23_{C}, 24_{C} or 25_{C}, thereby enabling the user to perform the corresponding tooth cleaning processes in a correct way. However, the aforesaid embodiments of the present invention are merely the preferred embodiments of the present invention, but are not restrictive of the present invention; hence, any other type of tooth cleaning head for use in tooth cleaning is applicable to the tooth cleaning kit 100 of the present invention. Besides, in the embodiment of the present invention, the connector 11 of the ergonomic and durable handle 10 corresponds in shape and cross section to the connection receptacle 21 of the tooth cleaning head 22, 23, 24 or 25_{C} and is, for example, of a semicircular cross section. The connection receptacle 21 and the connector 10 can be any modifications such as screw type, friction type, or click-on type, etc., and are connectible with each other for enabling the connection receptacle and the connector to be direction-sensitive, and unlikely to rotate and skid with each other Hence, the resultant tooth cleaner is not only direction-sensitive, but also unlikely to rotate and skid.

In addition, the user-friendly curvature 13 of the ergonomic and durable handle 10 is also dentally ergonomic to guide a user to automatically retract his or her cheeks or tongues, respectively, while the front half part of the ergonomic and durable handle 10 is entering into the user's mouth, for giving the user a wider and clear view of the posterior teeth and lingual teeth in the user's mouth from the mirror before he or she, thereby encouraging the user to clean his or her posterior teeth and lingual teeth in a correct way for effectively removing food deposits and plaque that accumulate in the mouth, particularly between the teeth and then effectively prevent his or her teeth from bacterial buildup and resulting in dental problems, e.g., caries (cavities), gingivitis, and periodontitis, accordingly.

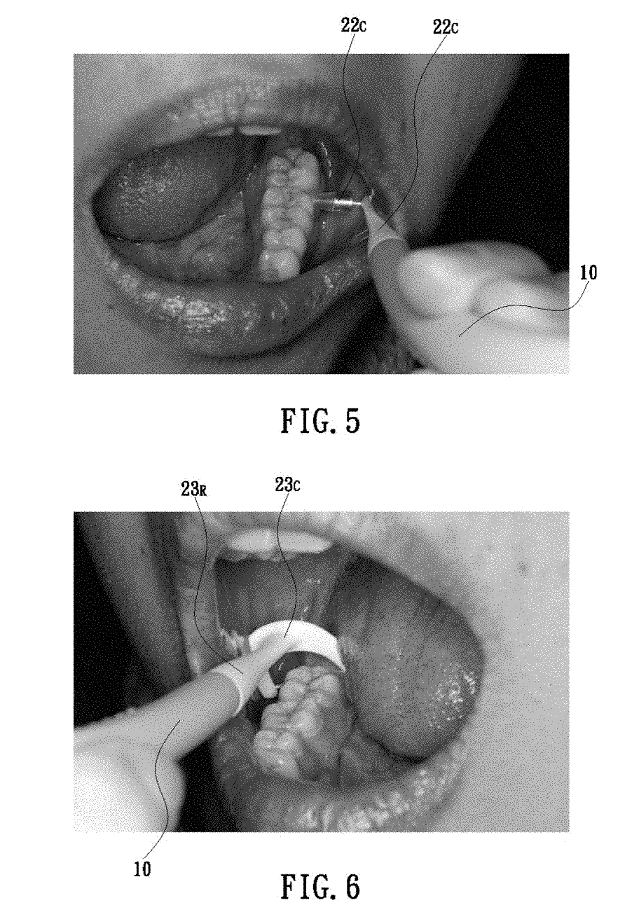

After the interdental brush head 22, the rake-like dental floss pick head 23 or the knife-like dental floss pick head 24 or the tooth brushing head 25 is selected and attached to the front end 10_{F} of the ergonomic and durable handle 10 as required, the whole cleaner becomes longer and user friendly, this is particularly true for the rake-like dental floss pick head 23, please refer to FIG. 6 of the present invention, it can easily access the interdental surfaces of posterior teeth from a front approach. Please refer to FIG. 5 of the present invention, under a dental bridge, braces, or any splinted appliances where no floss can get in, the interdental brush head 22 will be the only tool for cleaning such interdental surfaces. With this dental ergonomic and durable handle 10, a tip of the interdental brush head 22 can easily approach from both buccal and lingual or facial and palatal sides and access interdental gap between tooth.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A tooth cleaning tool having one end for alternatively and respectively replacing a plurality of multifunctional and disposable tooth cleaning heads, comprising:
an ergonomic and durable handle, having a front end and a rear end extending from a middle section thereof, respectively, to form a first included angle, which ranges from 155° to 170°, between a tangent line of the front end and a tangent line of the rear end, wherein a front end of the handle is protruded with a connector; and
at least one of a plurality of multifunctional and disposable tooth cleaning heads, each having a cone shaped supporting rod and a cleaning head component, respectively, wherein the cleaning head component is disposed at or adjacent to the tip end of the supporting rod and extends in a direction to form a second included angle, which ranges from 90° to 135°, between a central line of the cleaning head component and a central line of the supporting rod; and a connection receptacle is disposed at the base end of the supporting rod and is configured to firmly join together with the connector such that the ergonomic and durable handle and a corresponding one of the multifunctional and disposable tooth cleaning heads can be alternatively and respectively coupled together to form a specific tooth cleaner for providing a specific tooth cleaning function.

2. The tooth cleaning tool of claim 1, wherein the multifunctional and disposable tooth cleaning heads include at least an interdental brush head, a rake-like dental floss pick head, a knife-like dental floss pick head and a tooth brushing head.

3. The tooth cleaning tool of claim 2, wherein the connector corresponds in shape and cross section to the connection receptacle.

4. The tooth cleaning tool of claim 3, wherein the connector and the connection receptacle are of semicircular cross sections.

5. The tooth cleaning tool of claim 3, wherein the connection receptacle and the connector are a screw type, a friction type, or a click-on type, and are connectible with each other for enabling the connection receptacle and the connector to be direction-sensitive, and unlikely to rotate and skid with each other.

6. The tooth cleaning tool of claim 4, wherein the ergonomic and durable handle is in a length which ranges from 7˜16 centimeters.

7. The tooth cleaning tool of claim 5, wherein the ergonomic and durable handle is in a length which ranges from 7˜16 centimeters.

8. The tooth cleaning tool of claim 6, wherein the ergonomic and durable handle is of a polygonal cross section.

9. The tooth cleaning tool of claim 7, wherein the ergonomic and durable handle is of a polygonal cross section.

10. The tooth cleaning tool of claim 8, wherein the interdental brush head includes the cone shaped supporting rod and an interdental brush, wherein the interdental brush has one end connected to a tip end of the supporting rod and the other end extending in a direction to form the second included angle, which ranges from 90° to 135°, between a central line of the interdental brush and the central line of the supporting rod.

11. The tooth cleaning tool of claim 9, wherein the interdental brush head includes the cone shaped supporting rod and an interdental brush, wherein the interdental brush has one end connected to a tip end of the supporting rod and the other end extending in a direction to form the second included angle, which ranges from 90° to 135°, between a central line of the interdental brush and the central line of the supporting rod.

12. The tooth cleaning tool of claim 8, wherein the tooth brushing head includes the cone shaped supporting rod and a plurality of tooth brushes, wherein each of the tooth brushes has one end connected to the supporting rod adjacent to the tip end thereof and the other end extending in a direction to form the second included angle, which ranges from 90° to 135°, between a central line of the tooth brush and the central line of the supporting rod.

13. The tooth cleaning tool of claim 9, wherein the tooth brushing head includes the cone shaped supporting rod and a plurality of tooth brushes, wherein each of the tooth brushes has one end connected to the supporting rod adjacent to the tip end thereof and the other end extending in a direction to form the second included angle, which ranges from 90° to 135°, between a central line of the tooth brush and the central line of the supporting rod.

14. The tooth cleaning tool of claim 8, wherein the rake-like dental floss pick head includes the cone shaped supporting rod and a rake-like dental floss pick, wherein the rake-like dental floss pick has two arms each having one end connected to the tip end of the supporting rod and the other end extending laterally from the supporting rod to form the second included angle, which ranges from 90° to 135°, between a central line of the two arms and the central line of the supporting rod, and wherein the other ends of the two arms are spaced with each other for defining a cavity between the two arms and for holding a short strand of dental floss between the two arms across the cavity.

15. The tooth cleaning tool of claim 9, wherein the rake-like dental floss pick head includes the cone shaped supporting rod and a rake-like dental floss pick, wherein the rake-like dental floss pick has two arms each having one end connected to the tip end of the supporting rod and the other end extending laterally from the supporting rod to form the second included angle, which ranges from 90° to 135°, between a central line of the two arms and the central line of the supporting rod, and wherein the other ends of the two arms are spaced with each other for defining a cavity between the two arms and for holding a short strand of dental floss between the two arms across the cavity.

16. The tooth cleaning tool of claim 8, wherein the knife-like dental floss pick head includes the cone shaped supporting rod and a knife-like dental floss pick; wherein the knife-like dental floss pick has a first arm and a second arm; the first arm has one end connected to the tip end of the supporting rod, and the other end extending laterally from the supporting rod to form a third included angle, which is below 135°, between a central line of the first arm and the central line of the supporting rod; the second arm has one end connected to the supporting rod at a position adjacent to the tip end of the supporting rod and spaced with the first arm, and the other end extending laterally from the supporting rod to form a fourth included angle, which is above 45°, between a central line of the second arms and the central line of the supporting rod; and wherein the other ends of the first arm and the second arm are spaced with each other for defining a cavity between the first arm and the second arm and for holding a short strand of dental floss between the first arm and the second arm across the cavity

17. The tooth cleaning tool of claim 9, wherein the knife-like dental floss pick head includes the cone shaped supporting rod and a knife-like dental floss pick; wherein the knife-like dental floss pick has a first arm and a second arm; the first arm has one end connected to the tip end of the supporting rod, and the other end extending laterally from the supporting rod to form a third included angle, which is below 135°, between a central line of the first arm and the central line of the supporting rod; the second arm has one end connected to the supporting rod at a position adjacent to the tip end of the supporting rod and spaced with the first arm, and the other end extending laterally from the supporting rod to form a fourth included angle, which is above 45°, between a central line of the second arms and the central line of the supporting rod; and wherein the other ends of the first arm and the second arm are spaced with each other for defining a cavity between the first arm and the second arm and for holding a short strand of dental floss between the first arm and the second arm across the cavity.
